(19) United States
(12) Patent Application Publication
(10) Pub. No.: US 2022/0203466 A1
(43) Pub. Date: Jun. 30, 2022

(54) A METHOD OF CONTROLLING A PORTABLE AUTOMATED PANEL CUTTER

(71) Applicant: Kobots ApS, Odense S (DK)

(72) Inventors: Peter Murmann HARTVIGSEN, Svendborg (DK); Kristian DALGAARD, Odense C (DK); Knud ENGBJERG, Odense C (DK)

(73) Assignee: Kobots ApS, Odense S (DK)

(21) Appl. No.: 17/605,856

(22) PCT Filed: May 1, 2020
(86) PCT No.: PCT/DK2020/050125

§ 371 Date: Oct. 22, 2021

(30) Foreign Application Priority Data
May 1, 2019 (DK) PA 2019 70281

(51) Int. Cl. B23D 59/00; G05B 19/409

(52) U.S. Cl. CPC B23D 59/002; G05B 2219/36159; G05B 19/409

(57) ABSTRACT

The invention relates to a method of remote control of a portable automated panel cutter comprising a power cutter, the method comprises the steps of: establishing a wireless communication channel between the portable user device and the controller. Via the portable user device, select one of a plurality of predetermined cutting offs, each of which is definable by at least one predetermined measures type. For the selected cutting offs establishing a required number of measures corresponding to the at least one measures type. Via the portable user device, provide selected to the controller the established measures for the selected cutting off, and via the portable user device, initiating cutting operation of the panel cutter according to the selected cutting off and the established measures.

### FIELD OF THE INVENTION

The invention relates to a method of controlling a portable automated panel cutter to which a power cutter can be releasably mounted.

### BACKGROUND OF THE INVENTION

A majority of board cuts made by construction workers on construction sides can be made with a manual or automated panel cutter. Known panels cutters are typically stationary having a complex design and therefore not suitable for use in one construction site after the other i.e. not suitable for assembling and dismantle. Examples of such panel cutters can be found in EP1952957 and EP2143517.

Known panel cutter suitable for assembling and dismantling are typically manually or semi-automated requiring a user to operate it where it is located. Examples hereof can be found in U.S. Pat. Nos. 4,802,399 and 7,779,737.

Hence prior art panel cutters suffer from lack of either flexibility in place of use and/or requires manual operation to cut.

### SUMMARY OF THE INVENTION

The invention relates to a method of remote control of a portable automated panel cutter comprising a power cutter, wherein the position of the power cutter in X, Y and Z directions relative to a board to be cut and the orientation in an angle φ around the Z direction, is controlled by a controller controlling motors based on input provided by a user via a portable user device. Wherein the method of remote control of the panel cutter comprises the steps of: establishing a wireless communication channel between the portable user device and the controller. Via the portable user device, select one of a plurality of predetermined cutting offs, each of which is definable by at least one predetermined measures type. For the selected cutting offs establishing a required number of measures corresponding to the at least one measures type. Via the portable user device, provide to the controller the established measures for the selected cutting off, and via the portable user device, initiating cutting operation of the panel cutter according to the selected cutting off and the established measures.

Parring or linking a panel cutter and a portable user device to establishing a communication channel is advantageous in that it has the effect, that the panel cutter can be controlled remote from the location of the panel cutter. Hereby, the user of the panel cutter can communicate directly with the panel cutter and thereby reduce risk of human errors in that the user do not have to remember or write down measures of a board to be cut. Further, the user is more efficient in that time spend on cutting boards is reduced in that no measures are to be made manual on the board prior to cutting. Ultimately, this leads more efficient work from the user and less erroneous cuts and thereby better usage of materials which in this case is boards.

The cutting offs should be understood as predefined cuts that can be made to a board including cuts of a “side” and an “end” of a board. In addition, holes in a board and different special cutting offs and costume cutting offs can also be established. The cutting offs are stored in the controller and can thus be selected by the user e.g. via access to the controller from the portable user device. Accordingly, each of the cutting offs causes at least one cut by the power cutter, but a cutting off may also include at least two or three cuts.

The measure types are bound to the cutting offs and hence defining e.g. if a side cutting off is to be made at the left or right side of the board. Hence, if an end cutting off is selected, an example of a measure type could be “top” or “bottom” i.e. the selected end cutting is thus defined as either a top end cutting off or as a bottom end cutting off. In the same way, if a side cutting off is selected, an example of a measure type could be “right” or “left” side.

It should be mentioned, that a predetermined cutting off may only require one measure, that measure defining the cutting off. If e.g. a straight cut should be made dividing the board in two parts it may be irrelevant if the measure is taken from the top or bottom. Therefore, a predetermined straight end cutting off can be selected that is inherently defined by the measure type “end”. Thus, this cutting off only requires one measure and it does not matter if the measure is taken from the bottom or top of the board (left and right sides are the same to establish a straight cut). Accordingly, a straight end and straight side cutting off can be selected only requiring one measure. In some situations, e.g. when cutting is made in a new board, it makes no difference if the measure is taken from the top or bottom hence this is up to the developer of the software. Knowledge of where the panel cutter is making the cut if such cutting of is selected may be used if e.g. one board is damaged in one end, then of course the board is oriented so that the damaged is cut away.

The measures corresponding to the measure types should be understood as reference points for the panel cutter to starting points and end points of cutting operation of the power cutter of the panel cutter. Hence, if an end cutting off is selected and defined as a top end cutting off by the measure type, the measures defines where on the left side and right side the power cutter is to cut the board.

The measures are preferably established as a measure in inches, millimetre or centimetres on a physical structure on which or next to which the board to be cut is to be mounted. Measure may also be established from a blueprint or similar.

The measures, the measure type and cutting offs are in this document sometimes commonly referred to as input to the controller preferably from the portable user device.

The communication channel is advantageous in that it has the effect, that when the controller and the portable user device such as a smartphone or tablet are parring/linked this allows the user to control/communicate with the panel cutter from a remote location with the panel cutter. The communication channel may be implemented as Bluetooth, WiFi, etc. It should be mentioned, that when the communication channel is established, this step is typically not necessary to execute again after having made the first cutting operation.

The movement of the power cutter in the X, Y and Z direction is made with reference to a Cartesian coordinate system. The movement of the power cutter in the X, Y and Z directions is facilitated by a support frame to which a carriage holding the power cutter is attached. A board to be cut is positioned on board support which at least partly covers an inner space defined by the support frame. The board is positioned in the X/Y plan and when cutting the power cutter moves down in the Z direction towards the X/Y plane.

According to an embodiment of the invention, the method further comprises the step of selecting a measure type for the selected cutting off. This is advantageous in that it has the effect that the cutting off can be specified further in terms of left or right side of a side cutting off and top or bottom of an end cutting off, etc.

According to an embodiment of the invention, a position relative to the power cutter is defined in the control software controlling the cutting operation of the panel cutter as top end, bottom end, left side and right side of the board to be cut.

The definition of the orientation of the board relative to the panel cutter is preferably fixed i.e. the board should always be placed e.g. so that its bottom end is to the left (X=0) and its right side is “downwards” (Y=0). In this way the bottom right corner will be positioned in (0,0) and the controller can calculate all measures provided with reference to this point (0,0). It should be mentioned that any point could be defined as (0,0) but the above is simply the most logic choice.

This is advantageous in that it has the effect, that when a board is positioned relative to the power cutter of the panel cutter, the orientation of the board in terms of top end, bottom end, left side and right side is known by the controller. Thereby, when cutting off and measure type are selected, the controller is able to receive a predetermined sequence of measures without the user need specify which of the measures that are e.g. for the left and for the right side. This is advantageous in that it has the effect, that communication with the panel cutter is reduce leading to more flexible use especially for experienced users of the panels.

According to an embodiment of the invention, measures of length of the top end, bottom end, left side and right side is by the control software calculated from a reference point relative to the position of the board. Preferably, the reference point is determined from the position of the bottom right corner of the board. If the board is positioned on a support structure of a frame guiding the power cutter, the reference point is preferably established relative to the support frame. Further, the board may be positioned on a board guide spacing the board from the frame in the X and in the Y direction by first and second guide areas. In this situation the reference point would preferably be where the first and second guide areas meet i.e. this point would be the reference point (0,0) from which the controller controls the movement of the power cutter according to the received measures.

According to an embodiment of the invention, the plurality of predetermined cutting offs is selected from the list comprising: end cutting off, side cutting off, hole cutting off, product specific cutting off and custom cutting off. Being able to select between different cutting offs is advantageous in that it has the effect, that the geometry of the board when cut can be as desired. If e.g. both side, end and hole cutting offs are selected all four sides of a board can be tailored to the users requirements and in addition a hole in the board or part of a hole (a hole at one side of the board) can be cut.

The product cutting off is advantageous in that it has the effect, that it can be used for adding any type and combinations of cutting offs. An example of a product cutting off is a specific type or model of window. When all measures are established and provided to the panel cutter controller, the panel cutter is able to make all cuts needed to mount and covering the specific window. Only job for the user is to load and unload the panel cutter with boards.

The costume cutting off is advantageous in that it has the effect, that a user is able to save a current cutting e.g. if he is to use the same size of several boards. This makes the cutting of subsequent boards easier and faster.

According to an embodiment of the invention, two or more of the predetermined cutting offs can be combined. This is advantageous in that it has the effect the majority of board cuts made on a construction site can be made by the panel cutter of the present invention. By using a combination of two or more cutting offs, it is possible to at least partly match a desired geometry of the board to be cut.

Some costume cutting offs or combinations of simpler cutting offs may be complicated to provide measures for and initiate by voice communication. Accordingly, having a display on the portable user device or a user device which is part of the panel cutter via which input can be provided is advantageous in such situation.

According to an embodiment of the invention, new cutting offs can be established by the user saving a combination of cutting offs, measure types and/or measures. This is advantageous in that it has the effect that the new custom templates can be established. Especially if a user needs to cut a plurality of identical boards, the possibility of saving a previous cut and reuse this as a costume template later on is advantageous. In the situation where the controller is connected to a central server, new costume templates can be uploaded and distributed between users of the panel cutter.

According to an embodiment of the invention, two or more of the predetermined cutting offs is combined to establish a cutting off template. This is advantageous in that it has the effect, that otherwise required communication steps can be omitted and thereby increasing the effectivity of the user and of the panel cutter. Subsequent the creation of a cutting off template, this can be selected equally to a side or end cutting off.

According to an embodiment of the invention, the at least one predetermined measure type defining the at least one of the plurality of predetermined cutting off includes at least one of the measures of the list comprising: length of the left side of the board, length of the right side of the board, length of the top end of the board, length of the bottom end of the board and center of a hole to be cut in the board.

Selecting an end cutting off require measure type and measures to be inputted to the controller relating to which end and the length of both of the sides of the board. The panel cutter then uses these measures as start and end points of the cut to be made i.e. it e.g. starts cutting at the measure provided for the left side going towards the measure provided for the right side where the cutting then ends.

Wherein the input required by the side cutting off includes measures of length of the top end and of the bottom end of the board. Selecting a side cutting off require measure type and measures to be inputted to the controller relating to which side and the length of both the top and bottom ends of the board. The panel cutter then uses these measures as start and end points of the cut to be made i.e. it e.g. starts cutting at the measure provided for the top end going towards the measure provided for the bottom end where the cutting ends.

Preferably the measures provided are the measures of the desired board when cut, however it could also be the measures of the part of the board that is not intended to be used i.e. the waste part of the board.

According to an embodiment of the invention, the measures required by the hole cutting off includes at least two of the four edges of the hole and the location of the hole on the board is provided to the controller. Wherein a measure from a first side of the board to a first edge of hole is provided in the X direction. Wherein a measure from a second side of the board to a first edge of the hole is provided in the Y direction.

This is advantageous in that it has the effect, that hole is intuitive to measure and provide information of to the controller. If the location of the hole is in a top left corner of the board, only two measures namely from bottom to the first edge of the hole in the X direction and right side to the first edge of the hole in the Y direction needs to be provided. The second edges are the sides of the board and thus does not need to be cut.

If the hole is to be cut in the middle of the board, then four measures are needed two in the X direction one from a side of the board to each of the edges of the hole and two in the Y direction one from an end of the board to each of the edges of the hole.

According to an embodiment of the invention, the portable user device (38) is a smartphone, laptop or a tablet having a display, a speaker and a microphone. This is advantageous in that it has the effect, that communication with the panel cutter can be easily controlled from a location distant to the panel cutter via a smartphone which most craftsmen do carry around. Hence, almost every craftsmen are potential users of the panel cutter. Access to communication with the panel cutter from the portable user device typically required application specifically developed to this purpose

According to an embodiment of the invention, the user communicates with the portable user device (38) via a headset. Preferably the communication channel between the portable user device and the headset is wireless i.e. data communication is established via Bluetooth, WiFi, or similar wireless communication protocols. This is advantageous in that it has the effect that, the user can communicate via the headset and thereby does not use hands when providing input to the controller. An alternative to headset is intelligent glasses such as Google glasses or similar. The headset may be any kind of headset including the so-called bone connector type.

According to an embodiment of the invention, the initiation of the cutting is made via the portable user device from a location remote to the panel cutter. The initiation of the cutting is preferably made via the portable user device and thereby via the communication channel between the portable user device and the controller. Accordingly, the initiation of the cutting does not have to be made on or at the panel cutter but can be made from a location remote from the panel cutter. This is advantageous in that it has the effect, that the cutting can then be made while the user is walking towards the panel cutter and thereby time is saved on the cutting operation making the user spend his time more effective.

According to an embodiment of the invention, the communication channel between the portable user device and the controller is bidirectional. This is advantageous in that it has the effect that, the user can communicate selections and measures to the controller and the controller can communicate what has been received and ask for acknowledgement of the received prior to cutting.

According to an embodiment of the invention, communication from the controller to the portable user device reflects the input provided from the portable user device to the controller. This is advantageous in that it has the effect, that the received input is provided to the user and if the input is wrong in any way, the user may abort the cutting operation and start over again with providing input to the controller.

According to an embodiment of the invention, during the time, the user walks towards the panel cutter, the user communicates measures to the controller and/or the controller requesting an acknowledgement from the user of communicated measures. This is advantageous in that it has the effect, that control of the panel cutter can be done by the user in a period of time where the user cannot perform any work i.e. during transportation between work station and the location of the panel cutter. Hence, the time spend on walking between work station and panels saw is utilised.

According to an embodiment of the invention, one or more further communication channels are established between the panel cutter and one or more further portable user device. This is advantageous in that it has the effect, that two or more users can be connected and thereby communicate with the panel cutter. Thereby the utilisation of the panel cutter is increased leading to faster payback time and more users can benefit from the cutting operation performed by the panel cutter.

According to an embodiment of the invention, the portable user device is activated prior to initiate voice communication with the panel cutter. This is advantageous in that it has the effect, that communication from user to colleagues is not confused with communication to the panel cutter. Thereby time-consuming cancelation of commands and maybe even dangerous situations are avoided.

The activation of the portable user device may be initiated via the headset if such is used. The activation could be a seldom used word, a sequence of words, a sequence of movements or clapping and the like. A hardware component may be used for the activation such as e.g. drumming on a headset used.

The voice communication may be bi-directional understood as a user is sending voice input to the panel cutter and the user receives a voice response from the panel cutter. The voice input may be recognized by means of speech recognition and the response may be generated by means of speech synthesis.

According to an embodiment of the invention, the translation of voice communication to machine language is established with reference to one common dictionary. The number of words in the dictionary is limited and the words used are very specific and are preferably all used and related to cutting offs, measure types and measures.

According to an embodiment of the invention, the measures are provided from the portable user device to the controller via voice commands.

This is advantageous in that it has the effect, that measures can be provided as they are made i.e. without using hands to type in the measures. Thereby, efficiency of the user of the panel cutter is increased in that the user, when looking at the measuring tape can provide the measure to the panel cutter. When all measures are provided to the panel cutter, the panel cutter can cut the board as the user walks towards the panel cutter i.e. the cutting operation is done as the user walks towards the panel cutter which also saves time compared to conventional cutting of board on construction sides.

According to an embodiment of the invention, the controller communicates to the portable user device via voice commands. This is advantageous in that it has the effect, that the user of the portable user device can receive measurements in ear and therefore continue his work as he receives the communication from the controller.

According to an embodiment of the invention, the plurality of measures is provided to the controller in a predetermined sequence. To ensure that the measures for the left side of the board is also recognised as left side measures, it is preferred that the measures for the left side is provided to the controller prior to the measures for the right side or accompanied by a definition of the side to which the measures belongs. Again, to reduce risk of human errors the controller may require receiving the measures e.g. left side first, then right side of an end cutting off.

According to an embodiment of the invention, the controller presents the required measures to the user in the predetermined sequence. The controller communicating to the user that e.g. measure for left side is required is advantageous during an introduction period where the user learns how to operate the panel cutter. In addition to a voice communication from the controller, the information including previous and future steps in the control/communication may also be provided on a display of the portable user device.

The predetermined sequence may by explained to the user via voice or display of the portable user device, which is preferred for unexperienced users. However, experienced users may choose to disable this guiding feature and simply provided the measures in the order required and which the user learned during his experience.

According to an embodiment of the invention, the controller acknowledges the received input by communicating the received input back to the portable user device. This is advantageous in that it has the effect, that what is received by the controller, is communicated to the user and thereby if something is not received correct by the controller, the user will be aware of this prior to initiating a cutting operation and thereby get the possibility to correct or re-communicate the input. The feedback from the controller can either be provided to the user of the portable user device on a screen or display or as a voice command.

The acknowledge of the received input may also be understood as a confirmation of the received data or a chance for the user to confirm the received data.

According to an embodiment of the invention, the translation of the voice commands receive from the user is made in the portable user device. Alternatively, the translation is made at the controller and if the controller is a cloud-based controller in the cloud. In these alternatives, audio files are sent from the portable user device to the controller where they then are translated.

According to an embodiment of the invention, input is provided from the portable user device to the controller via a display of the portable user device. This is advantageous in that it has the effect, that the communication between user and controller is made visual and thereby the risk of human errors is reduced. This is both due to the fact that digital values do not need to be translated from voice to machine language and because the board to be cut can be visualised before cutting i.e. e.g. a mirrored board and confusions of right/left hand side measures can be avoided.

According to an embodiment of the invention, the measures are provided via the display of the portable user device by dragging a dragging point on a visualization of the board to be cut, wherein change of measures in terms of length of the cutting lines is displayed real-time on the display as the user performs the change by dragging the dragging point.

This is advantageous in that it has the effect, that input of two cutting lines can be provided to the controller at the same time. Further it is advantageous in that it has the effect, that the communication speed with the controller is increased in that acknowledged of input is not required. Alternatively, the measures can be typed in as numbers via the display or as a combination of numbers and dragging the dragging point.

According to an embodiment of the invention, the predetermined measures are displayed on a display of the portable user device along with a visual indication the cut between a first and a second of the predetermined measures. This is advantageous in that it has the effect, that the user, on the portable user device, is able to see the measures adjacent to the board to be cut, prior to the cut and thereby visualise how the board is going to be cut and thereby 1) if the measures are correct and/or 2) if the measures are provided to the controller in the correct order.

According to an embodiment of the invention, the controller is a cloud-based controller. The cloud-based controller is advantageous in that it has the effect, that the operation of the panel cutter does not required a physical controller i.e. the price of the panel cutter can be reduced.

A physical controller on the other hand is advantageous in that it has the effect, that it can operate the panel cutter independent of any connection to the internet and thereby internet connection is no hinderance for operation of the panel cutter.

According to an embodiment of the invention, the method further comprises the step of walking towards the panels saw after the cutting operation of the panel cutter is initiation.

This is advantageous in that it has the effect that, the total time used from taking measurements to the board is cut is reduced and utilised better.

According to an embodiment of the invention, the operation speed of the power cutter is “defined” by the blade of the power cutter.

Alternatively, by the material of the board. This is advantageous in that it has the effect, that the cutting speed is automatic aligned with the preferred cutting speed for the type of blade used on the power cutter. Preferably, information of the type of blade of the power cutter is provided to the controller automatic (e.g. by scanning or typing via the user device) this information is used by the controller to determine cutting speed i.e. the user will not make any errors in relation to cutting speed.

According to an embodiment of the invention, the cutting operation is temporary paused. Especially advantageous if cutting of more than one board is initiated. This is because then it is possible to take new measures e.g. for the last board up against a corner in a series of boards covering e.g. a wall.

According to an exemplary embodiment of the invention, the portable automated panel cutter is collapsible. This is advantageous in that it has the effect, that the portable automated panel cutter is collapsible and thereby be folded into a small space and unfolded at the construction site without significant mounting effort from the user.

According to an exemplary embodiment of the invention, the portable automated panel cutter is at least partly collapsible. This is advantageous in that it has the effect, that the portable automated panel cutter is at least partly collapsible and thereby be at least partly folded into a small space and unfolded at least partly at the construction site without significant mounting effort from the user.

According to an exemplary embodiment of the invention, a cutting tool of the power tool is a sawblade.

### THE DRAWINGS

For a more complete understanding of this disclosure, reference is now made to the following brief description, taken in connection with the accompanying drawings and detailed description, wherein like reference numerals represent like parts:

FIG. 1 illustrates a portable automated panel cutter

FIG. 2 illustrates communication related to a straight cut

FIG. 3 illustrates communication related to a slanting cut, and

FIG. 4 illustrates communication related to a combination cutting offs.

### DETAILED DESCRIPTION

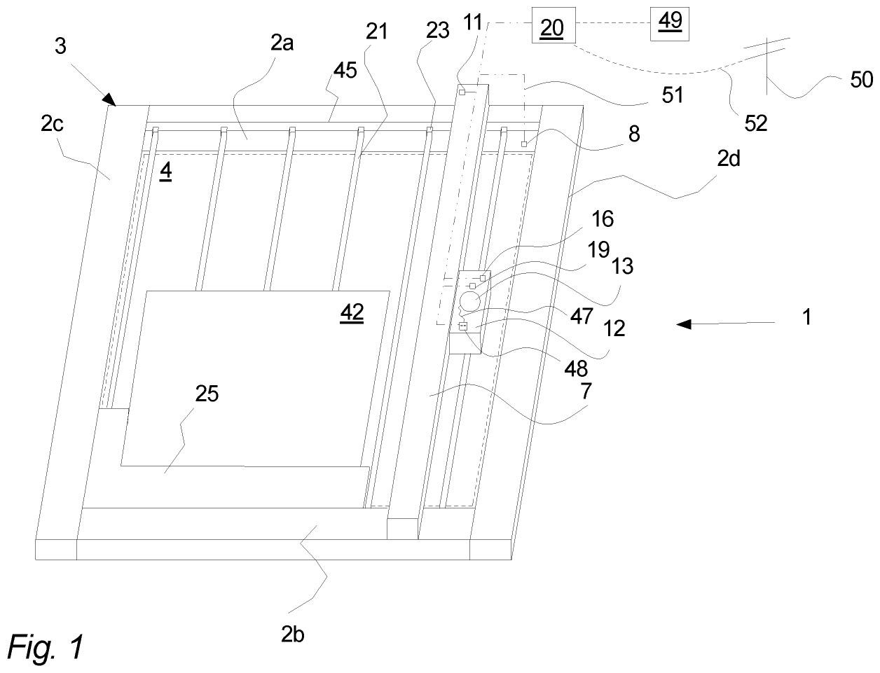

FIG. 1 illustrates a portable automated panel cutter 1. The panel cutter 1 is portable meaning that it can be packed away e.g. in bags when not in use. Accordingly, the panel cutter 1 is advantageous in that when it is not in used it can literally be stored on a shelf at a workshop or similar. When needed again it is easy to carry the dismantled panel cutter 1 to the site where it is needed. Further, craftsmen such as carpenter and bricklayers are often carrying a lot of building materials during the day. To protect their body, they are advised not to carry more than 14-20 Kg at the time. Therefore, the panel cutter support frame 3 of the present invention is advantageous in that it can be dismantled in various parts which does not exceed the recommended weight.

The panel cutter 1 comprises a support frame 3 built from four frame releasably mounted profiles 2a-2d as illustrated on FIG. 1. When the support frame 3 is in its upright position, the first frame profile 2a is referred to as the top profile, the second frame profile 2b is referred to as the bottom profile, the third frame profile 2c is referred to as the left profile and the fourth profile 2d is referred to as the right profile. Hence, the top 2a and bottom 2b profiles are parallel extending their longitudinal axes in the first direction referred to as the X direction. These are spaced by the paralleled transvers left 2c and right 2d profiles extending their longitudinal axes in the second direction referred to as the Y direction.

The support frame 3 of FIG. 1 further comprises board support 21 at least partly covering the inner support area 4. The board support 21 is releasably mounted on board support fixations. The board support 21 facilitates support of the board 42 to be cut. Further, the board support 21 facilitates support for a board guide 25 ensuring that the board 42 is positioned correct in the inner support area for the panel cutter 1 to cut the board 42.

At least the top frame profile 2a comprises a first longitudinal opening 45 which facilitates access to a first carriage transmission part. The transmission part facilitates a releasably mounting of a carriage 7 to the support frame 3, in fact the transmission part facilitates moving the carriage 7 along the X direction i.e. parallel to the top frame profile 2a. Further, the first longitudinal opening 45 facilitates access to a first carriage bearing (not illustrated). The first carriage bearing facilitates a releasably mounting of a carriage 7 to the support frame 3. The first carriage bearing is not mandatory, even though it is preferred in that it helps carrying the weight of the carriage 7 when releasably mounted to the support frame 3.

The top frame profiled 2a may also comprise a second longitudinal opening (not illustrated) which may facilitate access to the first carriage bearing.

On FIG. 1 only one longitudinal opening 45 is illustrated on the first side of the first frame profile 2a. It should be mentioned, that if both openings are used, one of these openings could be on a second side of the top profile 2a. The second side being an upper side when the panel cutter 1 is in an upright position. This is especially true in an embodiment where the support frame 3 is in an upright position, then the downward force applied to the weight carrying carriage bearing and mounting hereof would be downward against the point of contact between the bearing and support frame 3 instead of a point of contract between the bearing and the side of the second opening. With this said, the bearing may be designed having a spherical form distributing the force applied from the carriage 7 to the bearing equally independent of the position of the support frame 3.

It should be noted, that it may be advantageous to equip the bottom profile 2b with one or both of the openings including transmission and bearing parts. In the embodiment where one or more of these are implemented this can be done as described above in relation to the top profile 2a.

As mentioned the support frame 3 is part of a portable automated panel cutter 1. As mentioned, attachable to the support frame 3 is a carriage 7 and attachable to a tool holder carriage of the carriage 7 is a tool holder 12. Finally, attachable to the tool holder 12 is a power cutter 13. A controller 20 is controlling the operation of the panel cutter 1 via input data received from a user. A user can be any person that needs to cut material. Carpenters and bricklayers are examples of persons that during a working day are cutting a lot of boards 42 and hence would benefit from an automation of their cutting processes.

The electric parts of the panel cutter 1 (motors, controller, power cutter, etc.) is powered either from power supply cable 51, 52 connecting the power cutter 1 to the utility grid 50 or from an energy storage 49 preferably implemented as one or more batteries. In an embodiment, the tool holder 12 is equipped with a power socket 48 to which the electric wire 47 from the power cutter 13 is connected. In this way the power cutter 13 can be controlled by controlling power to the power socket 48. The power socket 48 may also have other locations on the panel cutter 1, however the location on the tool holder 12 or at the controller 20 is preferred.

For safety reasons emergency stop, safety stop, end stop, etc. may be implemented at appropriated locations at or close to the panel cutter 1. These are not illustrated, but are preferably hardwired to the controller 20 in order to increase safety for both the panel cutter 1, users hereof and it surroundings.

In this context the term “panel cutter” should be understood as a machine for cutting or sawing sheets into predetermined dimensions and/or numbers e.g. on a horizontal plane, slanted plane or vertical plane.

In this document, a board 42 to be cut by the portable automated power cutter 1 should be understood widely including any kind of lumber that can be cut by a power cutter as described below. Further, a board in this document also includes other materials than lumber, hence a board 42 should be understood as any of the following materials plywood, chipboard, gypsum, medium-density fibreboard, concrete, (precast) masonry, clinker, tiles, steel, fiber-cement board, etc.

The orientation of the board on the panel cutter i.e. which side/end of the board is left, right, top and bottom can be defined in software of the controller. Measures are typically made from left to right and from bottom to top. Accordingly, the measures provided to the controller 20 is handled according to the determined orientation of the board 42 orientated on the board support 21. In the examples below, the orientation is provided on the figures to avoid doubt.

The power cutter 13 is a standard handheld power cutter which when not mounted in the panel cutter 1 can be used for standard handheld power cutting. In this context, the term “power cutter” should be understood as an angle grinder, circular saw, jigsaw or other type of handheld cutting device. The power cutter 13 comprises a “cutter tool” in the form of e.g. a saw blade, grinder blade, jigsaw blade or any other kind of cutting tool for attachment to a power cutter 13 and thereby facilitating cut or saw of a material by conducting a circulating, oscillating or reciprocating motion.

The controller 20 is preferably a standard industrial programmable logic controller programmable with control software enabling control of the operation of the motors/displacement means, vacuum cleaner and power cutter 13. The vacuum cleaner may be powered when the power tool is started, this can be detected by monitoring power consumption of the power cutter 13 or it can be running continuously if desired.

The power cutter 13 may be powered when a user has initiated a cutting operation. Preferably, the controller 20 is controlling the power supply to the power cutter 13 via a relay. The relay controls power to a power socket located on the panel cutter 1, to which the plug of the power cutter 13 (and vacuum cleaner) is connected. In this way, when the controller 20 powers up the power socket, power is supplied to the power cutter 13 which is then turned on. As one can understand, the embedded power switch normally turning the power cutter 13 on is in its on position when the power cutter 13 is mounted in the tool holder 12 for this way of turning on and off the power cutter is possible. The same is true for the power switch of the vacuum cleaner. The power socket may also be located e.g. on the control box and powering the power cutter 13 via an extension cord.

Depending on the instructions provided by the user for where on the board 42 the cut has to be made, the controller 20 then controls the motors 8, 11, 16, 19 and thereby the movement of the power cutter 13 in the X, Y, Z and φ directions as described above. As can be understood this control includes operation of more than one motor at the time to be able to perform a slanting cut i.e. one definition of automated is that e.g. the motors controlling the movement of the power cutter in the X and Y direction are operated simultaneously. The speed of the individual motors is not necessarily the same, the speed depends e.g. of the inclination of a slanting cut.

It should be mentioned that the controller 20 may also be a cloud-based controller i.e. the panel cutter 1 does not have a physical controller. In this embodiment, the user communicates wirelessly with the cloud-based controller which again communicate wirelessly with the power cutter 1. This is advantageous in that then it is easy to update the control software on the panel cutters, however it requires a stabile wireless (internet) connection to operate the panel cutter 1.

The controller 20 is able to prioritise incoming jobs either based on input from one or more users or based on the fact, that if two jobs can be cut on the same board 42, these two job are executed subsequently to increase efficiency of the work flow.

The controller 20 receives input from a user via a user interface. The input relates to size and geometry of the board that is needed i.e. that is cut from the board 42. Hence, e.g. on a wall or floor to be built, from a drawing, etc. the user establishes measures of geometry of a board needed to cover a specific area. These measures preferably include one of the following length right side, length left side, length top and length bottom. When one or more of these measures are established they are provided to the controller 20 via the user interface. The controller 20, based on the received input, then controls the motors 8, 11, 16, 19 and thereby the position and orientation of the power cutter 13 and powers on the power cutter 13 to cut a board complying with the established measures.

The user interface may be implemented as a screen or display via which the user can provide the established measures to the controller 20. The measures may be provided to the controller 20 via predetermined templates (so-called cutting offs) prepared for receiving particular measures in a particular sequence.

The user interface may be part of the panel cutter 1 or may be a portable user device 39 communicating with the controller 20 via a wireless communication channel 38. The portable user device 39 may be a tablet or a smartphone having appropriate software for receiving and communicating the measures from the user to the controller 20. If a smartphone is used for communication with the power cutter 1, the measures may be inputted via voice commands that is translated to software code/machine readable language in the smartphone prior to communicating with the controller 20 or audio files may be sent to the controller 20 for the translation.

Hence, since the user device used for communication between the user and the controller 20 of the panel cutter 1 is a portable user device 39 such as a smartphone, this enables controlling the panel cutter 1 from a location remote to the panel cutter 1. Such remote location may be an area such as a room next to the area or room in which the panel cutter 1 is located. The possibility of remotely controlling the panel cutter increases the efficiency of the user e.g. in that time spend walking from where measures are established to the panel cutter 1 is used on cutting a board by the panel cutter 1. Further, time spend on marking on the board where to cut with a power cutter 13 (not mounted in the panel cutter 1) is eliminated when cutting with automated power cutter 1.

Communication between the user and the panel cutter 1 can be made by typing in information such as measures and choices via a display of the portable user device 39. This way of communicating is however seen as an alternative to the preferred way of communicating which is communication via voice commands and preferably bi-directional voice communication. Such bi-directional voice communication between a user and the panel cutter 1 may be realized by speech recognition of the user's speech and speech synthesis on the panel cutter 1 side to generate an audible response to the users information communicated from the user.

The preferred implementation of the speech recognition and speech synthesis according to the present invention is based on one common dictionary used for both the speech recognition and for the speech. An example of the principle of the bi-directional communication according to the present invention is to transmit a voice request from the user to the controller 20 of the panel cutter 1. The voice request is recognized by means of speech recognition using the common directory. An example of such voice request could be selecting a cutting off. In response hereto, a voice response from the controller 20 is transmitted back to the user. The voice response is generated by means of speech synthesis using the common directory. An example of voice response could be prompting a measure corresponding to a measured type defining the selected cutting off.

It should be mentioned, that the speech recognition and synthesis can be handled either on the user device 39 (smart phone, tablet or laptop), on a cloud server or on the controller 20. If handled on the cloud server or controller 20 the sound files are communicated thereto for processing.

It should be mentioned, that prior to sending the initial voice request, a hardware-initiated wakeup call is preferably made to the controller 20. The hardware wakeup call is included to avoid undesired activation of the panel cutter by voice commands. Hence, before the controller 20 is able to receive voice commands from the user, the user needs to initiate (wakeup) the ability to use voice command via the communication channel 38. Such hardware wakeup call can be pushing a button, making other sounds that is not confusable with a voice command or specific voice commands dedicated for wake call.

When communicating with the panel cutter 1, the user provides instructions and measures to the panel cutter. In embodiments, the panel cutter 1 sends back to the user the information received for the user to be able to verify it. The individual pieces of the communication from the panel cutter 1 to the user may be disabled to make the control of the panel cutter more user friendly. I.e. it is up to the user to determine which information that he would like to be able verify prior to cutting with the panel cutter 1.

It should be mentioned, that the step of establishing the communication channel 38 may include the step of user identification. Hence the user, prior to providing information to the panel cutter 1 is identifying himself e.g. by communicating a password and/or a username to the panel cutter 1. Alternatively, or in addition, the user identification may be used each time, the user is going to use the panel cutter e.g. prior to “waking up” the panel cutter 1.

Preferably, when the user has provided information to his portable device 39, the (voice) command e.g. measures along with e.g. username, time, etc. is communicated to the controller 20. At the controller 20, the relevant information is translated to machine language such as G-code.

The communication with the controller 20 is preferably limited to follow a number of predetermined standards or templates referred to in this document as so-called cutting offs. Each cutting off is predetermined and selectable via the portable user device 38 having access to a cutting off database. The cutting off database may be an online database or embedded in data storage of the controller 20.

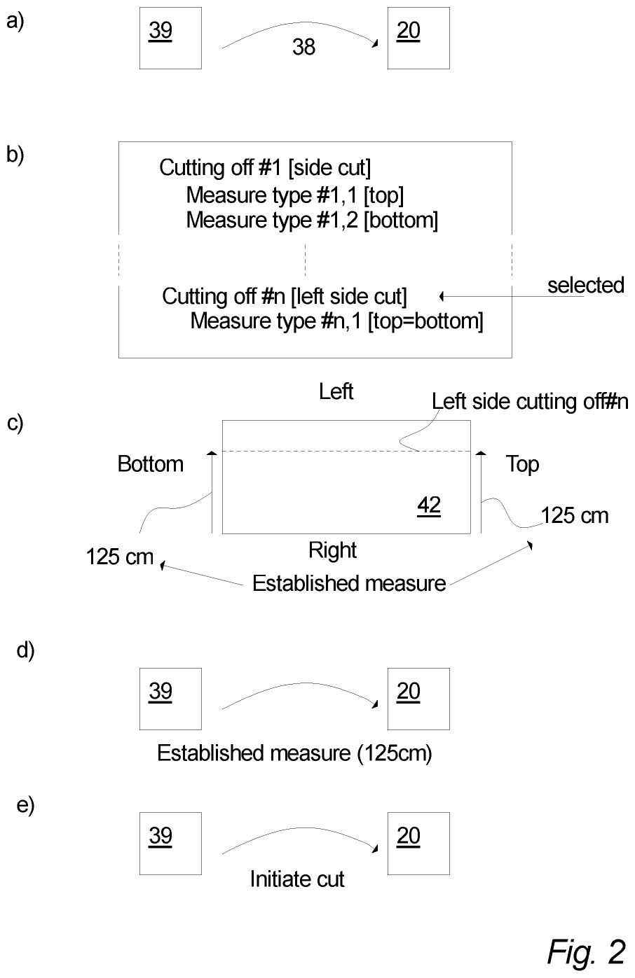

FIG. 2 illustrates the steps of communicating between user and controller 20. When a user first starts to use the panel cutter 1, the used needs to link his portable user device such as a smartphone 39 with the controller 20. Thereby a communication channel 38 is established. The communication channel 38 can be established via any type communication protocols such as Wi-Fi, Bluetooth, internet, etc.

After the step of establishing the communication channel 38 and preferably identifying himself to the panel cutter 1, the user is able to communicate with the panel cutter 1. As mentioned, the commands are limited in order to simplify both the software, but also to increase user friendliness. When the user faces an upcoming cutting job, he is to select one or more of the plurality of cutting offs needed to perform the cutting job. A very simple cutting job would be a straight cut of an end or side of the board 42. Such cut could be cutting the left side of the board straight through at a distance of 125 cm from the rights side of the board.

Such cutting operation would be initiated as follows. The user selects cutting off #n in that this particular cutting off is a template for straight side cuts. Then the user establishes the measure which in this example is 125 cm. The measure may be established e.g. physically from where the cut board is to be mounted or from a blueprint. When established, the measure is provided to the controller 20 and finally, the user can initiate the cutting operation from his smartphone. Either before or after providing the measures, the user may indicate that he has positioned a new board 42 on the panel cutter 1, this can be done by saying e.g. new board to the panel cutter.

What happens in this simple example is that the user selects the cutting off. Either he knows the correct cutting off from experience, he looks it up in a manual or his is guided through the possibilities by the controller 20 communicating to the user via the portable user device 39. When the user has found and selected the “cutting off #n” (straight left side cut) his is to input the corresponding “measure type #n,1” also via the portable user device 39. The left side cutting off #n is a straight cut defined by only one measure type #n,1 i.e. top measure=bottom measure. The measure type #n,1 defining the cutting off #n is the measure from right side at the top and bottom of the board. Finally, the last step is to initiate the cutting which is also done via the portable user device 39. For safety reasons, the initiation of the cutting operation may include both a voice confirmation of the “cut” command and a physical confirmation such as pushing a bottom of the user device 39 or associated head set. In this straight cut example there are only one measure type in that the distance from the right side at the top and bottom of the board 42 are the same to perform a straight cut. As will be described below, typically one cutting off is defined by at least two measure types to allow slanting cuts.

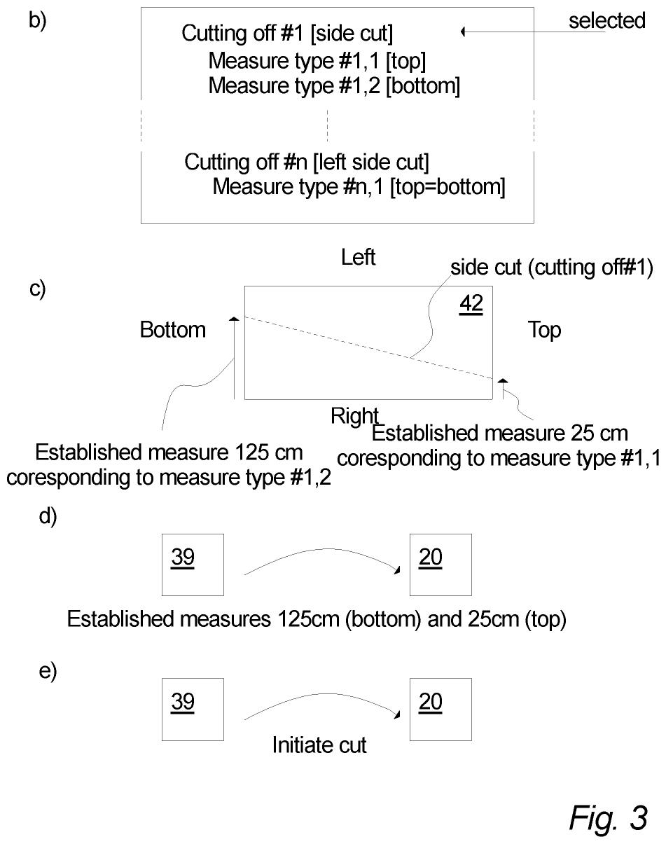

FIG. 3 illustrates an example of communication between the user and the controller 20 when the user would like to perform a slanting cut. If no communication channel 38 is established, this is the first to do. If this is not the first cut, the communication channel 38 exists and the user can jump directly to the step of selecting cutting off. In this example, the cut has to be made on the left side of the board 42 starting 125 cm from the right side at the bottom end of the board 42 and ending 25 cm from the right side at the top end of the board 42.

Accordingly, the user selects the cutting off #1, which in this example is the template for a slanting cut in the left side of the board 42. Cutting off #1 is defined by measure type #1,1 and measure type #1,2 i.e. the measures to the start and stop points on the board 42. In this example measure type #1,1 is top end and measure type #1,2 is bottom end. Hence, the cutting off #1 i.e. the slanting cut of the left side of the board 42 is defined by measure type #1,1 (a top measure) and measure type #1,2 (a bottom measure).

Again, as described with reference to FIG. 2, the user after selecting the cutting off is establishing the measures corresponding to measure type #1,1 and #1,2. In this example, the measure corresponding to measure type #1,2 is 125 cm and the measure corresponding to measure type #1,1 is 25 cm. Preferably, the controller 20 is expecting these measure in a predefined sequence so that first the measure for the top (measure type #1,1) is provided and then subsequently the measure for the bottom (measure type #1,2). Of course, the other way around is also a possible sequence of supplying information to the controller 20. Preferably, measures for a board 42 is made from left to right and from bottom to top. Therefore, it is preferred that the controller prompts the user for measures in this order in order to make the communication user friendly. Further, a predetermined sequence is advantageous in that then measures are provided in the same way each time. Of course, the control software can facilitate the input of a measure associated with the measure type, however this would contribute with unnecessary uncertainties and complexity so even though it is possible it is not desired.

The controller 20 may ask and thereby inform the user of which measure that is needed and subsequently wait for input. Alternatively, the more experienced user can disable this service and simply input measures in the required sequence.

Further, the controller 20 may upon receipt of information (measure, cutting off, initiating cutting, etc.) repeat the received information and ask the user to verify. This feature is advantageous at least when learning to use the panel cutter 1 in that nothing is cut before all input received has been verified by the user. The verification can either be made via voice communication or via a display illustrating where the cut is made based on what is received. Any time during verification, the user is able to correct an input or start all over. Some users may find it easiest to correct via a display, where corrections can be made by drag and drop on the display.

Returning to FIG. 3, the selected cutting off #1 (left side slanting cut) defined by measure type #1,1 (bottom end) and measure type 1,2 (top end) is now to be defined from measures established in the real world e.g. from the construction part where the cut board needs to be mounted. Hence the user, via the portable user device 38, first provides information of first the measure type i.e. the distance from right side of the board at the bottom end to where the cut has the start/stop and then the distance from right side of the board at the top end to where the cut has the start/stop. When done and verified (if not disabled) the user gets the opportunity to see where the cut is to be made on a display of the portable user device (if not disabled) and finally, the user is initiating the cutting operation.

The controller 20 determines where to start and stop the cut, when measures are received. The choice is made so that the direction of the cut is always made downwards/towards the bottom of the board i.e. against one or both of the support areas of the board support 25. This is to avoid that the power cutter 13 is lifting the board 42 while cutting and thereby create hazardous situations or imprecise cuts.

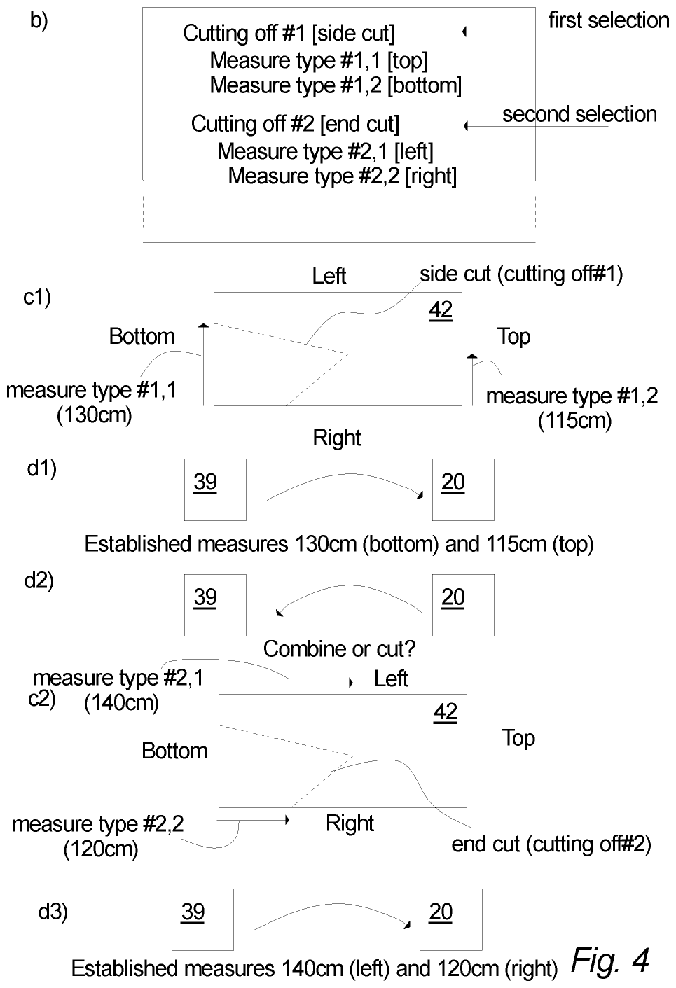

The principles of control of the panel cutter 1 described with respect to FIGS. 2 and 3 are the same for each cutting off selected or combined. FIG. 4 is an example of the combination of the side slanting cutting off #1 and an end slanting cutting off #2. One of these two cutting offs is selected (in this example cutting off #1; step b first selection) and subsequently defined by establishing the measures corresponding to the measure types #1,1 and #1,2 defining the cutting off #1 (step cl). This is done as described with respect to FIG. 3 above. In this example the bottom measure (measure type #1,1) is 130 cm and the top measure (measure type #1,2) is 115 cm. In this embodiment, the established measures are now provided to the controller 20 (step d1).

Then, the controller 20 asks the user if the user would like to initiate cut or combine the input with further input (step d2). In this embodiment, the user would like to combine with the slanting end cutting off #2 which is therefore selected (second selection step b). When this input is provided to the controller 20, the controller 20 prompts the user for measures corresponding to the measure types #2,1 (measure on left side from bottom to where cut is to start or stop) and #2,2 (measure on right side from bottom to where cut is to start or stop) defining the slanting end cutting off #2 again as described above. These measures are established in step C2 and provided to the controller 20 in step d3.

When all input is provided to the controller 20, the controller 20 may offer a visualisation of the board 42 marked with where the cuts are to be made (dotted line on the board 42) based on the received input (if not disabled). Finally, the user initiates the cutting operation via the portable user device 39 (step e, not illustrated on FIG. 4).

Accordingly, FIG. 4 illustrates an example of some of the bi-directional communication between the user and the controller 20 during “programming” of the controller 20 to perform a user defined cut of the board 42. More communication may of course exist if other cutting offs are to be combined with the above explained, if corrections are need, etc.

As mentioned, using a portable user device 39 for the communication between the user and the panel cutter 1 is advantageous in that the user in this way is able to provide the measures to the controller 20 just when they are established. I.e. no need for write down, pass on or trying to remember. By using a portable user device 39 in the form of a smartphone, the measures can be provided via voice communication which is simplifying the communication even more in that the measures can be communicated directly as they are read off e.g. of a folding rule.

As can be imagined, a number of different cutting off templates can be developed and stored in the cutting off database. Above different types of end and side cutting offs are described, but also cutting offs for cutting hols, specific products, tasks and for user customising can be made available in the database.

The customised cutting off is intended for being used by a user that needs to cut several identical cuts that might include e.g. a combination of different side and end cuts. Hence, when input to the first board is made, this input can be stored in the cutting off database and selected again when a new board with these particular measures or combination of cutting offs are needed.

The hole cutting off is intended for cutting a (most often) square formed hole in a board. Such hole could be for ventilation, cable tray, water piping, etc. The how can be placed anywhere on the board 42 and its location may be provided to the controller 20 to make the communication of measures for the hole more user friendly. In an embodiment, the hole cutting off is defined by three measuring types which are 1) center of hold, 2) length of hole and 3) width of hole. Based on these three measuring types, the controller is able to calculate with reference to the center of the hole where to cut the four sides to the desired hole.

Alternatively, the hole cutting off is defined as follows, first information of the location of the hole is provided (e.g. bottom), then the user is prompted to provide input of measure from left side of board 42 to start edge of hole, then the user is prompted to provide input of measure from left side of board 42 to end edge of hole and then from bottom of board 42 to end edge of hole (the start edge of the hole is the bottom of the board). If the user chose top left corner for location of the hole i.e. two sides of the hole is defined by edged of the board 42, he is only prompted to input measures for the two sides of the hole that needs to be cut. These measures could be from left of board 42 to end edge of hole and from bottom of board 42 to start hole

A task specific cutting off is a template for types of cuttings that are used often such as covering at windows openings, and the like. Accordingly, the measure types of a task specific cutting off may define length and width of a board suitable for use in the particular task. So that when choosing such cutting off, then only predetermined measures for e.g. length and with is the be provided to the controller which then is able to cut a board accordingly.

A product specific cutting off may be tailor made to a specific product such as mounting of a particular type of window in a roof, a particular type of door in a wall, etc. When mounting a roof window, the boards needed for covering and mounting are known on forehand e.g. if the inclination of the roof is known. Therefore, by selecting a cutting off for such particular type of roof window, it is possible simply to provide measures corresponding to the measure types defining the cutting off. Again, as with the above the utilisation of the time and thereby efficiency of the user is increased compared to the situation, where measures are taken, stored and then used later. With the present invention, the panel cutter 1 can start cutting while the user climbs down the roof, thereby reducing non-productive time.

Another example of a cutting off template is a so-called quick cut. The is designed for the most common cuts such as a square that only needs two cuts in that the other sides of the square is the edges of the board 42

Another example is a so-called rest board cutting off. The cutting off is chosen if a desired board can be cut from a part of a board that was cut previously. If such a rest board is used, the measures of this board is provided to the panel cutter 1 and then this rest board can be cut as a new board as explained above.

During the bi-directional communication between user and panel cutter 1, the user may abort or go one or more steps back if he realises he has provided erroneous information or made wrong choices. Abort is also activated if the user command is not provided within a given time period.

The end measures are in this description described as being taking from the right side i.e. the side of the board 42 that is downward supported by the board support 25 (when the frame 3 is in an upright position) and upwards towards the left side in either the bottom end or top end of the board 42. Similarly, the side measures are described as being taking from the bottom end i.e. the end of the board 42 that is to the left supported by the board support 25 and towards the top end in either the left side of right side of the board 42. This is of course just a matter of definition, but with a preferred reference point in (0,0) (X,Y) from the corner right side and bottom end, this definition is preferred though not the only one.

When the frame 3 is assembled, the carriage 7 is attached thereto and a power cutter 13 is mounted, a calibration routine may be executed to align the edge of the cutting tool of the power cutter 13 with this (0,0) reference point. In addition, the calibration routing also includes aligning the edge of the cutting tool of the power cutter 13 with Z=0 in the point where it cuts all way through the board 42 when position in both X=0 and Y=0. The calibration routine may be a mechanical adjustment i.e. the user, prior to his first use, is manually pulling/adjusting the carriage 7 and power cutter 13 to ensure that the edge of the cutting tool of the power cutter 13 is in (0,0,0) (X,Y,Z). When this is done, this position is stored in the controller 20 and used as reference point for each of the measures that are established and subsequently used to define the cutting offs.

An alternative calibration routine can be implemented via the controller 20. This includes controlling each of the four directions (X, Y, Z, φ) individually so that the edge of the cutting tool of the power cutter 13 finally is in the “(0,0,0,0) position”. This alternative calibration routine can be made with the power cutter 13 powered and thereby activated cutting tool or with an unpowered power cutter 13.

Yet an alternative, is to measure the position of the carriage 7 and tool holder 12 on the support frame 3 via sensors. In this way, for each of the four axis, the end position is registered by a sensor and from these registrations and movements detected e.g. by encoders, the controller 20 is able to determine the position of the carriage 7, tool holder 12 and thereby of the power tool 13. Hence calibration in this embodiment is adjusting the end sensors so that they are precise aligned with a desired position of the inner support area 4.

In an exemplary embodiment, a reference to a portable automated panel cutter 1 is a reference to a machinery that does not comprise a power cutter 13 i.e. the contrary to a standard CNC cutter. The power cutter 13 is a stand-alone tool and the tool holder 12 of the portable automated panel cutter 1 is designed to fit to and hold the power cutter 13. When mounting the tool holder 12 in a tool holder carriage, the power cutter 13 is mounted to the machinery and the portable automated panel cutter 1 is able to cut a board to be cut 42.

In an exemplary embodiment, when a power cutter 13 is mounted in the automated panel cutter 1, the tool holder 12 (or indirectly the carriage 7) facilitates moving the power cutter 13 and thereby the cutting tool both in the Z-direction and around the Z-direction i.e. the angle of rotation φ. Hence, the cutting tool is able to be move from front of board to be cut 42 towards the back of the board to be cut 42. In addition, the cutting tool is able to be moved in an angle φ around the Z-axis providing a freedom of 180 degrees, preferably plus minus a margin of 2 degrees. Such movement around the Z-axis ensures that circular cuts can be made and it distinguishes the present portable automated panel cutter 1 from known portable tools having a frame and a power tool in the form of a milling cutter. Using a milling cutter as power tool 13 reduces complexity in control of the movement of the power tool in that it only has to be moved in the X, Y and Z directions.

In an exemplary embodiment, the portable automated panel cutter 1 is equipped with means for indicating that a board to be cut 42 is correct positioned on the board support 21 and thereby that the portable automated panel cutter 1 is ready to cut. Such means can be implemented as a button the user loading the panel cutter 1 with the board can push when done. Alternatively, such means can be implemented as one or more sensors positioned in the support frame 3. In any case, the means provides a “load” signal to the controller 20 which upon receiving the load signal allows the user to initiate a cutting.

The portable automated power cutter is dynamic in the sense that two subsequent cuts are different from each other. This is at least true for the majority of cuttings.

As found from the above, the present invention relates to a method of remotely controlling a panel cutter 1. When assembled and loaded with a board 42 (or at least powered up), the user is able to create a communication channel 38 between e.g. his smartphone and the controller 20 of the panel cutter 1. Via the smartphone and communication channel 38 the user is able to select a cutting off i.e. a template matching the cut he is about to make in the board 42. The cutting off is defined by measure types i.e. types of measures (right/left side, top/bottom end, etc.) and corresponding measures are established for these measure types. When established, these measures are provided to the controller 20 and based here on the controller 20 controls the movement of the cutting edge of the cutting tool of the power cutter 13.

The cutting operation is initiated by the user either when the user has provided the last measure to the controller 20 or when the user has verified the measures as received by the controller 20. The controller 20 may ask the user to verify on different levels i.e. after each piece of information is received, after information related to a particular cutting off is received, after all information is received, etc. The level of verification is user definable.

The communication between user and controller can be made via voice commands, via a display or a combination hereof. Preferably, the communication is bi-directional voice communication which, if the user selects so, can be visualised on a display and preferably also corrected via the display. The display is preferably the display of the smartphone (portable user device).

Finally, is should be mentioned that all figures and associated description may be combined so that commands and choices made and described in relation to one embodiment can be used in relation to another embodiment and vice versa.

### LIST

1. Portable automated panel cutter
2. Frame profile
   a. First frame profile
   b. Second frame profile
   c. Third frame profile
   d. Forth frame profile
3. Support frame
4. Inner support area
7. Carriage
8. First carriage motor
11. Second carriage motor
12. Tool holder
13. Power cutter
16. First tool displacement means
19. Second tool displacement means
20. Controller
21. Board support
25. Board guide
38. Wireless communication channel
39. Portable user device
42. Board to be cut
45. First longitudinal opening
47. Electric wire from power cutter
48. Electric socket powering the power cutter
49. Energy storage
50. Utility grid
51. Motor power supply cables
52. Power supply cable
   X. First direction
   Y. Second direction
   Z. Third direction
   φ. Angle of rotation
   θ. Angle of inclination of the panel cutter from horizontal

1. A method of remote control of a portable automated panel cutter comprising a power cutter,
wherein a position of the power cutter in X, Y and Z directions relative to a board to be cut and an orientation in an angle φ around the Z direction, is controlled by a controller, controlling motors based on input provided by a user via a portable user device,
wherein the method of remote control of the panel cutter comprises the steps of:
a) establishing a wireless communication channel between the portable user device and the controller,
b) via the portable user device, selecting one of a plurality of predetermined cutting offs, each of which is definable by at least one predetermined measures type,
c) for the selected predetermined cutting off, establishing a required number of measures corresponding to the at least one predetermined measures type,
d) via the portable user device, providing to the controller the established required number of measures for the selected predetermined cutting off, and
e) via the portable user device, initiating cutting operation of the panel cutter according to the selected predetermined cutting off and the established required number of measures.

2. The method according to claim 1, further comprising the step of selecting a measure type for the selected predetermined cutting off.

3. The method according to claim 1, wherein a position relative to the power cutter is defined in a control software controlling the cutting operation of the panel cutter as a top end, a bottom end, a left side, and a right side of the board to be cut.

4. The method according to claim 1, wherein measures of length of a top end, a bottom end, a left side, and a right side is by a control software calculated from a reference point relative to a position of the board.

5. The method according to claim 1, wherein the plurality of predetermined cutting offs is selected from a list comprising: end cutting off, side cutting off, hole cutting off, product specific cutting off, and custom cutting off.

6. The method according to claim 1, wherein two or more of the predetermined cutting offs can be combined.

7. The method according to claim 1, wherein new cutting offs can be established by the user saving a combination of cutting offs, measure types and/or measures.

8. The method according to claim 1, wherein two or more of the predetermined cutting offs are combined to establish a cutting off template.

9. The method according to claim 1, wherein the at least one predetermined measures type defining the one of the plurality of predetermined cutting offs includes at least one of measures of a list comprising: length of a left side of the board, a length of a right side of the board, a length of a top end of the board, a length of a bottom end of the board, and a center of a hole to be cut in the board.

10. The method according to claim 1, wherein measures required by a hole cutting off includes at least two of four edges of a hole and a location of the hole on the board is provided to the controller,
wherein a measure from a first side of the board to a first edge of the hole is provided in the X direction,
wherein a measure from a second side of the board to the first edge of the hole is provided in the Y direction.

11. (canceled)

12. The method according to claim 1, wherein the user communicates with the portable user device via a headset.

13. The method according to claim 1, wherein the initiation of the cutting operation is made via the portable user device from a location remote to the panel cutter.

14. (canceled)

15. (canceled)

16. The method according to claim 1, wherein during a time the user walks towards the panel cutter, the user communicates measures to the controller and/or the controller requests an acknowledgement from the user of the communicated measures.

17-19. (canceled)

20. The method according to claim 1, wherein the measures are provided from the portable user device to the controller via voice commands.

21. (canceled)

22. The method according to claim 1, wherein a plurality of measures is provided to the controller in a predetermined sequence.

23. (canceled)

24. The method according to claim 1, wherein the controller acknowledges the by communicating the input back to the portable user device.

25. (canceled)

26. (canceled)

27. The method according to claim 1, wherein measures are provided via a display of the portable user device by dragging a dragging point on a visualization of the board to be cut, wherein change of measures in terms of length of the cutting lines is displayed real-time on the display as the user performs the change by dragging the dragging point.

28. (canceled)

29. (canceled)

30. The method according to claim 1, wherein the method further comprises the step of walking towards a panels saw after the cutting operation of the panel cutter is initiated.

31. (canceled)

32. (canceled)

33. The method according to claim 1, wherein the portable automated panel cutter is collapsible.

34. (canceled)

35. The method according to claim 33, wherein a cutting tool of the power tool is a sawblade.
